(19) United States
(12) Patent Application Publication
(10) Pub. No.: US 2025/0252348 A1
(43) Pub. Date: Aug. 7, 2025

(54) DISTRIBUTED MODEL TRAINING METHOD, DEVICE, AND MEDIUM

(71) Applicant: SHANGHAI ARTIFICIAL INTELLIGENCE INNOVATION CENTER, Shanghai (CN)

(72) Inventors: Weigao SUN, Shanghai (CN); Yiran ZHONG, Shanghai (CN); Zhen QIN, Shanghai (CN); Weixuan SUN, Shanghai (CN); Shidi LI, Shanghai (CN); Dong LI, Shanghai (CN); Xuyang SHEN, Shanghai (CN)

(21) Appl. No.: 18/669,120

(22) Filed: May 20, 2024

(30) Foreign Application Priority Data
Feb. 1, 2024 (CN) 202410147440.3

(51) Int. Cl. G06N 20/00

(52) U.S. Cl. CPC G06N 20/00

(57) ABSTRACT

A distributed model training method includes that: the training of an internal iteration with a preset number of internal iterations is performed on a preset model through a computation process, to obtain a first node model parameter value of a current global iteration; a second node model parameter value of the current global iteration of a second computing node in a distributed system is acquired through a communication process running in parallel with the computation process, and a first ALLReduce model parameter value of the current global iteration is determined according to the first node model parameter value and the second node model parameter value; and external iteration is performed through the computation process by using a second ALLReduce model parameter value of a last global iteration, to obtain a target model parameter value of the current global iteration.

### CROSS-REFERENCE TO RELATED APPLICATION(S)

This disclosure claims priority to Chinese Patent Application No. 202410147440.3 filed with the China National Intellectual Property Administration (CNIPA) on Feb. 1, 2024, the disclosure of which is incorporated herein by reference in its entirety.

### TECHNICAL FIELD

The present disclosure relates to the field of artificial intelligence technologies, for example, a distributed model training method, a device, and a medium.

### BACKGROUND

With the rapid development of artificial intelligence technologies, the scale of deep neural network models is increasingly large. In order to improve the training efficiency of large-scale deep neural network models, distributed model training may be adopted for training.

For a distributed model training scheme, a small-batch parallel optimization method is usually adopted, such as stochastic gradient descent (SGD) under a distributed data parallel (DDP) paradigm.

However, when the method is applied to a relatively large distributed computing node cluster, the communication overhead is relatively large, and it is costly to construct a huge high-performance cluster with high-speed communication interconnectivity. The existing distributed model training scheme is difficult to apply to a cluster with a limited bandwidth, and has poor expandability and low training efficiency.

### SUMMARY

The present disclosure provides a distributed model training method, a device, and a medium.

A distributed model training method applied to a first computing node in a distributed system is provided. The method includes that: training of an internal iteration with a preset number of internal iterations is performed on a preset model through a computation process, to obtain a first node model parameter value of a current global iteration, where the preset model includes a machine learning model, and the global iteration includes the internal iteration and an external iteration; a second node model parameter value of the current global iteration of a second computing node in the distributed system is acquired through a communication process, and a first ALLReduce model parameter value of the current global iteration is determined according to the first node model parameter value and the second node model parameter value, where the communication process runs in parallel with the computation process, the second computing node is a computing node in the distributed system except the first computing node, and the second node model parameter value is obtained after the second computing node performs training on the preset model with the preset number of internal iterations; and in response to the current global iteration being a non-first global iteration, a second ALLReduce model parameter value of a last global iteration is acquired through the computation process, and the external iteration is performed by using the second ALLReduce model parameter value to obtain a target model parameter value of the current global iteration, where the target model parameter value of the current global iteration is configured as an initial model parameter value of a next global iteration or a model parameter value after training on the preset model is finished.

A distributed model training apparatus disposed in a first computing node in a distributed system is provided. The apparatus includes a node model parameter value determination module, a global model parameter value determination module and a target model parameter value determination module. The node model parameter value determination module is configured to perform, through a computation process, training of an internal iteration with a preset number of internal iterations on a preset model, to obtain a first node model parameter value of a current global iteration, where the preset model includes a machine learning model, and the global iteration includes the internal iteration and an external iteration. The global model parameter value determination module is configured to acquire, through a communication process, a second node model parameter value of the current global iteration of a second computing node in the distributed system, and determine a first ALLReduce model parameter value of the current global iteration according to the first node model parameter value and the second node model parameter value, where the communication process runs in parallel with the computation process, the second computing node is a computing node in the distributed system except the first computing node, and the second node model parameter value is obtained after the second computing node performs training on the preset model with the preset number of internal iterations. The target model parameter value determination module is configured to: in response to the current global iteration being a non-first global iteration, acquire, through the computation process, a second ALLReduce model parameter value of a last global iteration, and perform the external iteration by using the second ALLReduce model parameter value to obtain a target model parameter value of the current global iteration, where the target model parameter value of the current global iteration is configured as an initial model parameter value of a next global iteration or a model parameter value after training on the preset model is finished.

An electronic device is provided. The electronic device includes at least one processor and a memory communicatively connected to the at least one processor. The memory stores a computer program executable by the at least one processor, and the computer program, when executed by the at least one processor, causes the at least one processor to perform the distributed model training method.

A distributed system is provided. The system includes multiple computing nodes, and any one computing node of the multiple computing nodes is configured as the first computing node.

A computer-readable storage medium is provided. The computer-readable storage medium stores a computer instruction, and the computer instruction is configured to, when executed by a processor, implement the distributed model training method.

A computer program product is provided. The computer program product includes a computer program, and the computer program, when executed by a processor, implements the distributed model training method.

It should be understood that the contents described in this section are not intended to identify key or critical features of the embodiments of the present disclosure, nor intended to limit the scope of the present disclosure. Other features of the present disclosure will be readily understood from the following description.

### BRIEF DESCRIPTION OF DRAWINGS

FIG. 1 is a flowchart of a distributed model training method according to an embodiment of the present disclosure;

FIG. 2 is a flowchart of another distributed model training method according to an embodiment of the present disclosure;

FIG. 3 is a flowchart of still another distributed model training method according to an embodiment of the present disclosure;

FIG. 4 is a schematic diagram of an overall flow of a distributed model training method according to an embodiment of the present disclosure;

FIG. 5 is a schematic diagram of comparison between a processing flow of a distributed model training method according to an embodiment of the present disclosure and a processing flow in the related art;

FIG. 6 is a schematic structural diagram of a distributed model training apparatus according to an embodiment of the present disclosure; and

FIG. 7 is a schematic structural diagram of an electronic device that implements a distributed model training method according to an embodiment of the present disclosure.

### DETAILED DESCRIPTION

It should be noted that the terms “first”, “second” and the like in the Description and claims of the present disclosure, and in the foregoing drawings, are used for distinguishing between similar objects and not necessarily for describing a particular order or sequential order. It should be understood that the data so used are interchangeable as appropriate so that the embodiments of the present disclosure described herein can be implemented in an order other than those illustrated or described herein. Moreover, the terms “include” and “have” as well as any variations thereof are intended to express a non-exclusive inclusion, for example, a process, a method, a system, a product, or a device that includes a series of steps or units is not necessarily limited to those steps or units expressly listed, but may include other steps or units not expressly listed or inherent to such process, method, product, or device.

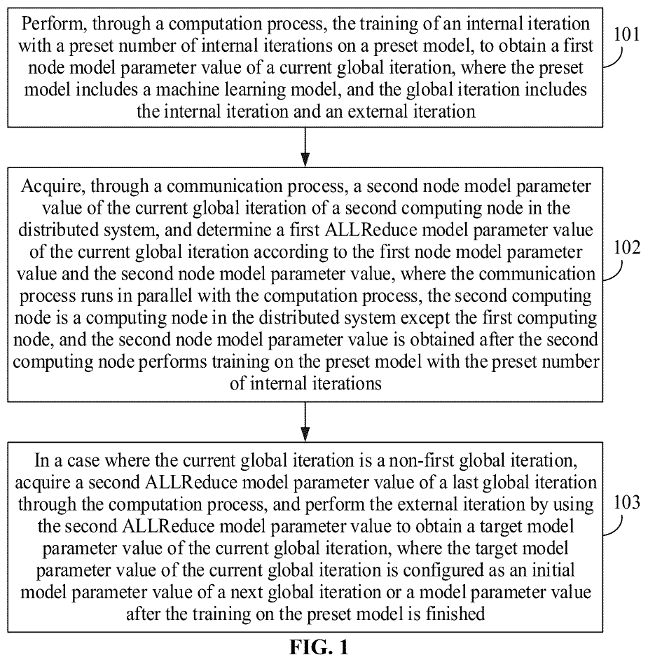

FIG. 1 is a flowchart of a distributed model training method according to an embodiment of the present disclosure. The embodiment of the present disclosure may be applicable to a case in which the model training is performed by using a distributed system. The method may be performed by a distributed model training apparatus. The distributed model training apparatus may be implemented in a form of hardware and/or software. The distributed model training apparatus may be disposed in a first computing node in the distributed system. The distributed system includes multiple computing nodes, which are not limited in the specific quantity. The first computing node may be any one of the multiple computing nodes, and different computing nodes may be trained by using different training sample data. In some embodiments, the distributed system may be a graphics processing unit (GPU) cluster that includes multiple computing nodes, and each GPU card may be understood as one computing node. As shown in FIG. 1, the method includes the following steps.

In step 101, the training of an internal iteration with a preset number of internal iterations is performed on a preset model through a computation process, to obtain a first node model parameter value of a current global iteration, where the preset model includes a machine learning model, and the global iteration includes the internal iteration and an external iteration.

In the embodiments of the present disclosure, the preset model includes a machine learning model, and the preset model may include a neural network model, for example, a deep learning model. A specific task corresponding to the preset model is not limited, such as image classification, semantic segmentation, point cloud processing, autoregressive language modeling, and bidirectional language modeling. In particular, in a large-scale model training scenario in which the preset model is a large-scale language model, the prominent technical effect may be obtained in the technical schemes of the embodiments of the present disclosure.

In the embodiments of the present disclosure, a preset number of iteration trainings may be performed on the preset model, and each time of iteration training is recorded as the global iteration. The global iteration includes the internal iteration (also referred to as an internal circulation) and the external iteration (also referred to as an external circulation). For one time of global iteration, the internal iteration is firstly performed, and then the external iteration is performed. After the current global iteration is completed, a next global iteration may be entered, that is, the internal iteration in the next global iteration is performed.

Exemplarily, the number of internal iterations may be preset and recorded as the preset number of internal iterations (or may be recorded as the number of local update steps or the number of internal circulation iterations). For each time of internal iteration, a random gradient descent method may be adopted for training. For example, training sample data corresponding to the current computing node is input firstly, forward pass computation is performed to obtain a loss, and then backward pass computation is performed to obtain a gradient; finally, a model parameter update operation (that is, an optimizer parameter update operation is performed) is performed to obtain a model parameter value of the current internal iteration. After the training of the preset number of internal iterations is performed, a model parameter value obtained by a last time of internal iteration is recorded as a node model parameter value of the current global iteration, and a node model parameter value obtained by the first computing node is recorded as the first node model parameter value.

A manner of performing an ALLReduce communication operation on a gradient in the technical schemes of the embodiments of the present disclosure is different from a manner of performing an ALLReduce communication operation on a gradient in the related art. In the internal iteration process, there is no need to perform the ALLReduce communication operation on the gradient, that is, the gradient obtained by each computing node is directly used for updating the model parameter thereof, the internal iteration is finished after the preset number of iterations (the preset number of internal iterations) are performed, and then the external iteration is entered.

In step 102, a second node model parameter value of the current global iteration of a second computing node in the distributed system is acquired through a communication process, and a first ALLReduce model parameter value of the current global iteration is determined according to the first node model parameter value and the second node model parameter value, where the communication process runs in parallel with the computation process, the second computing node is a computing node in the distributed system except the first computing node, and the second node model parameter value is obtained after the second computing node performs training on the preset model with the preset number of internal iterations.

In the embodiments of the present disclosure, each computing node runs the communication process and the computation process, and the communication process runs in parallel with the computation process. After the internal iteration in the current global iteration has performed the preset number of internal iterations, the ALLReduce communication operation may be initiated. The ALLReduce communication operation is an asynchronous operation, and the ALLReduce communication operation is initiated and then performed in the communication process, that is, the ALLReduce communication operation is performed in parallel with a computation operation in the computation process. The communication process may acquire a second node model parameter value of a current global iteration of a computing node (recorded as a second computing node, and the number may be one or more, which is determined by a total number of computing nodes included in the distributed system, and is generally the total number minus 1) except the first computing node in the distributed system. Internal iterations of different computing nodes are independently performed without mutual interference, that is, the second computing node and the first computing node separately perform the internal iteration by using different training sample data, and the processing manner of the internal iteration may be the same. However, since the training sample data is different, the first node model parameter value may be different from the second node model parameter value, and the ALLReduce needs to be performed. After the communication process acquires the second node model parameter value of the current global iteration, the ALLReduce computation is performed. For example, the preset model includes multiple model parameters, a model parameter value may be represented in a form of a vector or a matrix. For each model parameter (such as each element in the vector) included in the preset model, the ALLReduce parameter value of the current global iteration of the current model parameter is computed according to a value of the current model parameter in the first node model parameter value and a value of the current model parameter in the second node model parameter value. The computation manner may be averaging, and after the computation of the ALLReduce parameter value of each model parameter is completed, the first ALLReduce model parameter value is obtained through summarization.

In step 103, in a case where the current global iteration is a non-first global iteration, a second ALLReduce model parameter value of a last global iteration is acquired through the computation process, and the external iteration is performed by using the second ALLReduce model parameter value to obtain a target model parameter value of the current global iteration, where the target model parameter value of the current global iteration is configured as an initial model parameter value of a next global iteration or a model parameter value after the training on the preset model is finished.

In the embodiments of the present disclosure, model parameter update may be made based on the stale ALLReduce model parameter value when the external iteration is performed, thereby facilitating the overlapping of the communication and the computation. The external iteration is performed by using the ALLReduce model parameter value of the last global iteration (recorded as the second ALLReduce model parameter value), to obtain the target model parameter value of the current global iteration, and a specific processing manner of the external iteration is not limited, for example, the external iteration may be performed in a momentum updating manner. Further, it is determined through the communication process whether the asynchronous communication operation initiated in the last global iteration is completed, that is, it is determined whether the communication process has obtained the second ALLReduce model parameter value that is computed according to the node model parameter values in the last global iteration. If the second ALLReduce model parameter value has not been computed, wait for the computation to complete; or if the computation is completed, then the second ALLReduce model parameter value is acquired for the external iteration.

Exemplarily, the number of global iterations (recorded as the preset number of global iterations) may be preset. If it is determined, according to the preset number of global iterations, that the current global iteration is the non-final global iteration, that is, is not the final global iteration, then the target model parameter value of the current global iteration may be configured as the initial model parameter value of the next global iteration, and may be configured as an initial model parameter value of the first internal iteration of the next global iteration and an initial model parameter value of the external iteration of the next global iteration. If it is determined, according to the preset number of global iterations, that the current global iteration is the final global iteration, that is, the final global iteration, then the target model parameter value of the current global iteration may be configured as the model parameter value after the training of the preset model is finished.

Exemplarily, for the first global iteration, since the last global iteration does not exist, in the first global iteration, the external iteration may be skipped without being performed, or it may be understood that the target model parameter value obtained by the external iteration in the first global iteration is an initial model parameter value of the external iteration in the first global iteration, that is, the first external iteration does not update the model parameter. In this way, the external iteration is equivalent to always being one step later than the internal iteration.

According to the distributed model training method provided in the embodiments of the present disclosure, the process of performing the iteration training on the model is divided into the internal iteration and the external iteration, the model parameter value is locally updated through a certain number of internal iterations, and after an ALLReduce operation on model parameter values of distributed nodes is triggered, the completion of the ALLReduce operation is not required to be waited. During the ALLReduce operation, an ALLReduce operation result obtained by the last global iteration may be used in parallel, and the ALLReduce operation result is used for performing subsequent external iteration and internal iteration, whereby promoting the overlapping of the inter-node communication and the intra-node computation, and effectively improving the training efficiency. The distributed computing node cluster with the limited bandwidth can be better adapted, and thus the expandability is improved.

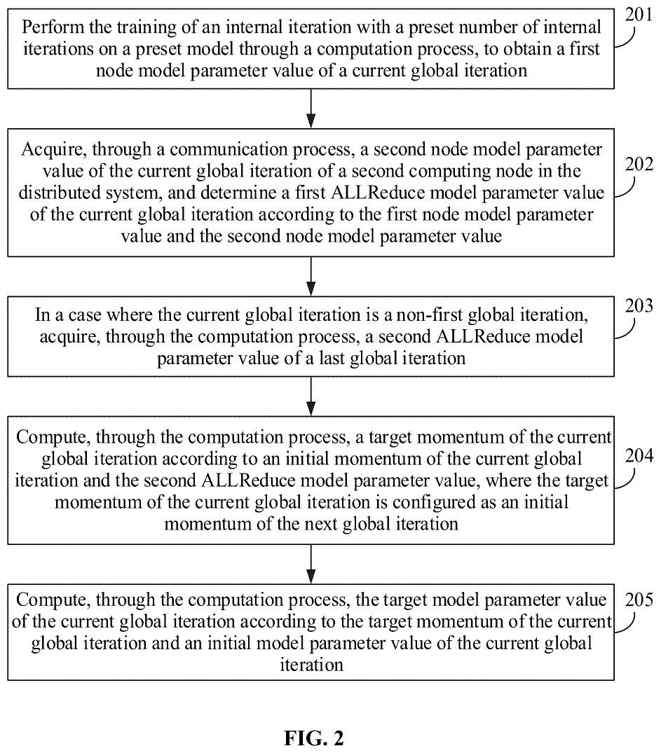

FIG. 2 is a flowchart of another distributed model training method according to an embodiment of the present disclosure. The embodiments of the present disclosure are optimized based on the above-described optional embodiments, and the external iteration is performed in a momentum updating manner. As shown in FIG. 2, the method includes the following steps.

In step 201, the training of an internal iteration with a preset number of internal iterations is performed on a preset model through a computation process, to obtain a first node model parameter value of a current global iteration.

Exemplarily, when the model training is started, training sample data and preset parameters may be input, where the preset parameters are an internal iteration learning rate γₜ, the preset number of internal iterations τ, a preset external iteration learning rate α, an external circulation trend factor β, the preset number of global iterations (which may also be understood as the preset number of external iterations) T, and an initial value of the external iterative momentum m₀. For example, m₀=0.

Exemplarily, distributed data parallel training of a large-scale deep neural network is used as an example, and the target may be represented as:

$${min}_{x} \frac{1}{G} {\sum }_{i = 1}^{G} {E}_{{ζ}_{i} ∼ {D}_{i}} {L}^{( i )} ( x ; {ζ}_{i} ) \qquad ( 1 )$$

where the target is to minimize the function with respect to the model parameter x∈Rⁿ. Rⁿ denotes an N-dimensional vector of real numbers. The optimization problem involves the sum of G working nodes (i.e., computing nodes), and each computing node is represented by an index i. For each working node i, the loss function L⁽ⁱ⁾ and the data sample ζᵢ extracted from the distribution Di (distribution of data samples for training) exist, and E represents expectation.

In the related art, the model parameter is copied to all working nodes in a communication group. Each working node i then obtains different batches of data samples and independently performs forward and backward pass to compute different losses L⁽ⁱ⁾ and gradients g⁽ⁱ⁾. In order to ensure the consistency of model parameters of the all working nodes in the same data parallel communication group, the gradients on the all working nodes are precisely synchronized through the ALLReduce operation, thereby forming an aggregated gradient g, that is,

$$g = \frac{1}{G} {\sum }_{i = 1}^{G} {g}^{( i )} .$$

Then, this aggregated gradient is used to update the model parameters on the all working nodes, to ensure the consistency of parameter values of each working node.

In the embodiments of the present disclosure, the global iteration includes the internal iteration and the external iteration, and the internal iteration is carried out in each computing node and includes a localized update. In this stage, each computing node maintains its dedicated model parameter set, thereby achieving the autonomous updating without the need for gradient synchronization at each step. After the preset number of internal iterations (recorded as a number τ of internal iterations) is completed, the training process transitions to the external iteration. The number τ of internal iterations are performed, k is recorded as a sequence number of an iteration corresponding to a current internal iteration in the current global iteration, and t is recorded as a sequence number of an iteration corresponding to the current global iteration (which is also equivalent to a sequence number of an external iteration). In the training process of internal iterations of the global iteration t, for each internal iteration from k=0 to k=τ−1, each computing node independently performs internal iteration operations involving forward pass (FP), backward pass (BP), and local update (LU). It should be noted that, in a process of performing a number τ of internal iterations, no gradient synchronization exists between computing nodes, thereby resulting in different model parameter values on each computing node i at the end of internal iteration. Therefore, a synchronization operation is required to coordinate model parameter values x_{t,τ}⁽ⁱ⁾ on the all computing nodes. The model parameter values x_{t,τ}⁽ⁱ⁾ on the all computing nodes are synchronized by adopting the ALLReduce operation and the external iteration.

The processing of FP and BP may be represented as follows:

$${g}_{t , k}^{( i )} = ∇ {L}^{( i )} ( {x}_{k , k}^{( i )} ; {ζ}_{t , k}^{( i )} ) . \qquad ( 2 )$$

The processing of LU may be represented as follows:

$${x}_{t , k + 1}^{( i )} = {x}_{t , k}^{( i )} - {γ}_{k} {g}_{t , k}^{( i )} . \qquad ( 3 )$$

In step 202, a second node model parameter value of the current global iteration of a second computing node in the distributed system is acquired through a communication process, and a first ALLReduce model parameter value of the current global iteration is determined according to the first node model parameter value and the second node model parameter value.

Exemplarily, after the internal iteration of the current global iteration is completed, each computing node separately starts the ALLReduce operation, which may be recorded as AAR(x_{t,τ}⁽ⁱ⁾). For the first computing node, the ALLReduce operation is performed on the first node model parameter value and the second node model parameter value, and the model parameters on the all computing nodes are accurately synchronized, for example, through computing the average value, specifically,

$$AAR ( {x}_{t , τ}^{( i )} ) = \frac{1}{G} {\sum }_{i = 1}^{G} {x}_{t , τ}^{( i )} ,$$

to ensure the convergence consistency.

In step 203, in a case where the current global iteration is a non-first global iteration, a second ALLReduce model parameter value of a last global iteration is acquired through the computation process.

In the embodiments of the present disclosure, unlike the related art, the ALLReduce operation is asynchronous with subsequent computation operations such as the subsequent external iteration and the internal iteration in the next global iteration, that is, the subsequent computation does not depend on a result of AAR(x_{t,τ}⁽ⁱ⁾), but utilizes the stale model parameter x_{t-1, τ}⁽ⁱ⁾, that is, utilizes AR(x_{t-1, τ}⁽ⁱ⁾). It should be noted that at this time AR(x_{t-1, τ}⁽ⁱ⁾) may not have been completed. Therefore, if it is checked that it has not been completed, then the wait operation wait(⋅) should be performed to ensure that AR(x_{t-1, τ}⁽ⁱ⁾) is performed.

The asynchronous ALLReduce operation is introduced, so that the overlapping of communication and computation in the whole training process can be promoted. In consideration of the actual situations of the cluster scale and the variable communication conditions, the seamless overlapping (i.e., complete overlapping) of the whole asynchronous communication and the whole computation can be achieved by configuring a proper number of local steps (a preset number of internal iterations) τ, the expandability is improved to 100%, the resource utilization rate in the distributed system is further improved, and thus the training efficiency is more effectively improved.

In step 204, a target momentum of the current global iteration is computed through the computation process according to an initial momentum of the current global iteration and the second ALLReduce model parameter value, where the target momentum of the current global iteration is configured as an initial momentum of the next global iteration.

Exemplarily, AAR(x_{t-1, τ}⁽ⁱ⁾) is performed to obtain x_{t-1, τ}, i.e., the second ALLReduce model parameter value, and the second ALLReduce model parameter value may then be used to update the stale external momentum. The initial momentum of the current global iteration is also the initial momentum of the external iteration of the current global iteration, and for the second global iteration, the initial momentum is m₀ as described above.

Exemplarily, the target momentum may be understood as a new momentum obtained after the momentum is updated, and a computation expression may be:

$${m}_{t} = β {m}_{t - 1} + ( {x}_{t - 1 , 0} - {x}_{t - 1 , τ} ) \qquad ( 4 )$$

mₜ represents the target momentum of the current global iteration, that is, the initial momentum of the next global iteration, mₜ₋₁ represents an initial momentum of the current global iteration, x_{t-1, 0} represents an initial model parameter value of the current global iteration, and x_{t-1, τ} represents a second ALLReduce model parameter value of the current global iteration.

For each external iteration, relative to using a new version of x_{t, τ,}, the stale external momentum lags behind by only one step. This strategy introduces a minimum of one-step staleness in the external iteration, which has minimal effect on the convergence of the network.

In step 205, the target model parameter value of the current global iteration is computed through the computation process according to the target momentum of the current global iteration and an initial model parameter value of the current global iteration.

Exemplarily, the computation expression of the target model parameter value of the current global iteration may be:

$${x}_{t + 1 , 0} = {x}_{t , 0} - α \cdot {m}_{t} \qquad ( 5 )$$

where, x_{t+1,0} represents the target model parameter value of the current global iteration, that is, the initial model parameter value of the next global iteration or the model parameter value after the training on the preset model is finished, and x_{t,0} represents the initial model parameter value of the current global iteration.

According to the distributed model training method provided in the embodiments of the present disclosure, a direction in which the model parameter is updated is modified in a momentum manner in the external iteration so that better training precision can be obtained.

In some embodiments, the step in which the target momentum of the current global iteration is computed through the computation process according to the initial momentum of the current global iteration and the second ALLReduce model parameter value includes: a delay penalty amount of the current global iteration is determined through the computation process; and the target momentum of the current global iteration is computed through the computation process according to the initial momentum of the current global iteration, the delay penalty amount of the current global iteration, and the second ALLReduce model parameter value. Therefore, a difference between different parameter versions during the updating of the external momentum is penalized by introducing a delay penalty, so that the noise introduced by an asynchronous nature into a training process is reduced, the convergence is enhanced, and the stability and performance of the overall training are improved.

In some embodiments, the step in which the target model parameter value of the current global iteration is computed through the computation process according to the target momentum of the current global iteration and the initial model parameter value of the current global iteration includes: momentum clipping is performed on the target momentum of the current global iteration through the computation process, so that a value of the momentum-clipped target momentum is in a preset interval; and a third product of the momentum-clipped target momentum of the current global iteration and a preset external iteration learning rate is computed through the computation process, and a difference value between the initial model parameter value of the current global iteration and the third product is computed to obtain the target model parameter value of the current global iteration. Therefore, the value range of the target momentum is limited to be within a preset interval, which can alleviate potential situations related to abnormal values in the updating of the external momentum, help to prevent the occurrence of the extreme value, enhance the convergence, and improve the stability of the overall training.

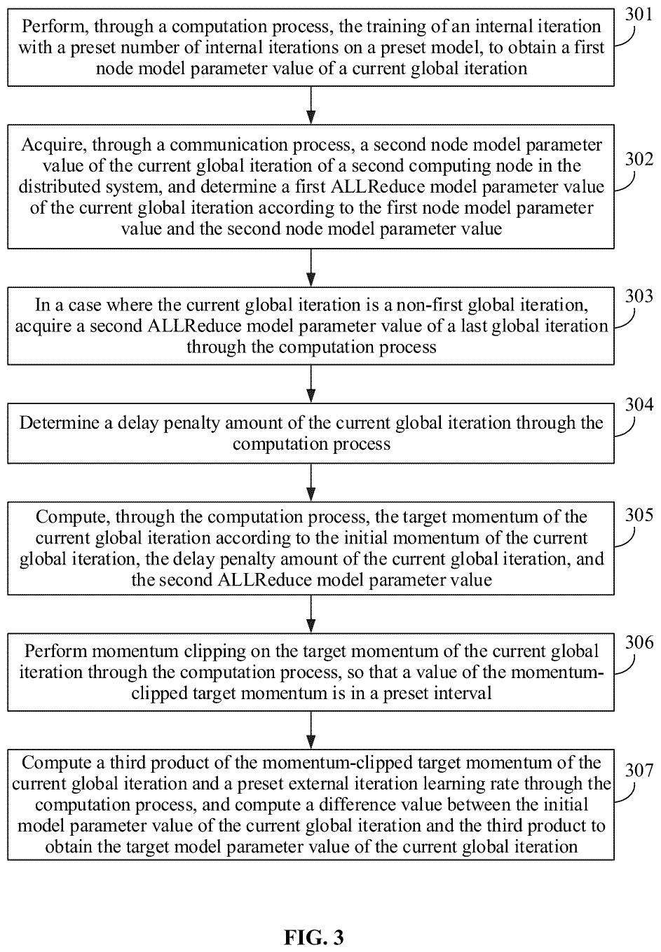

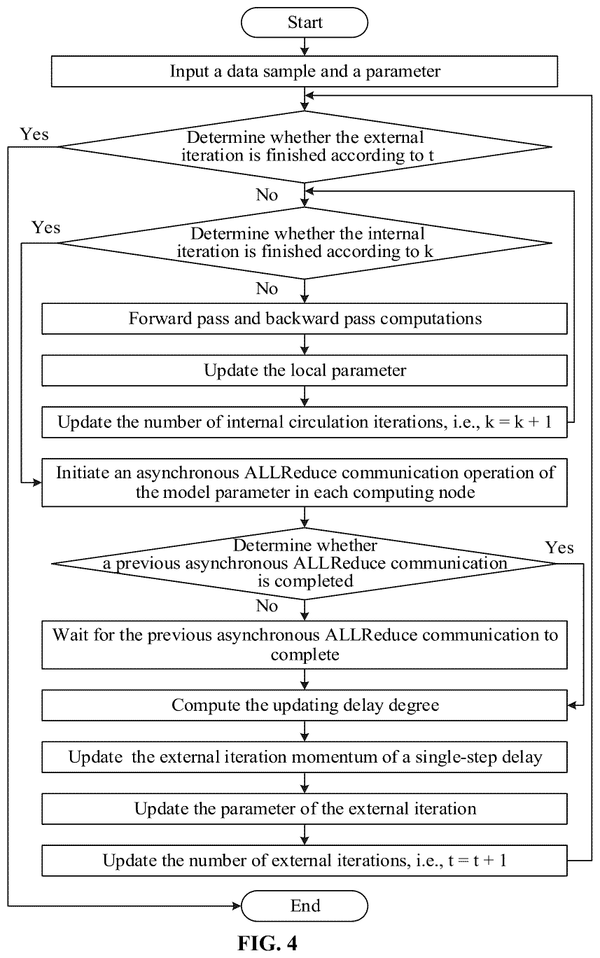

FIG. 3 is a flowchart of still another distributed model training method according to an embodiment of the present disclosure. The embodiments of the present disclosure are optimized based on the above-described optional embodiments, and the external iteration is performed in a momentum updating manner. FIG. 4 is a schematic diagram of an overall flow of a distributed model training method according to an embodiment of the present disclosure. The technical schemes of the embodiments of the present disclosure may be understood with reference to FIGS. 3 and 4.

As shown in FIG. 3, the method includes the following steps.

In step 301, the training of an internal iteration with a preset number of internal iterations is performed on a preset model through a computation process, to obtain a first node model parameter value of a current global iteration.

Exemplarily, as shown in FIG. 4, when the model training is started, a data sample and a parameter are firstly input, which may be a data sample in each computing node i and the foregoing preset parameter. In the training process of the internal iteration, forward pass and backward pass computations are performed, then the updating of the local parameter (model parameter) are performed (no gradient ALLReduce communication is performed), and the number of internal circulation iterations is updated, i.e., k=k+1. Then it is determined whether the internal iterations are finished according to the current value k, that is, whether k is equal to the preset number of internal iterations τ. If k is equal to the preset number of internal iterations τ, then the current model parameter is determined as the first node model parameter value, and if k is less than the preset number of internal iterations τ, then a related operation such as the forward pass and backward pass computations is performed again until k is equal to τ.

In step 302, a second node model parameter value of the current global iteration of a second computing node in the distributed system is acquired through a communication process, and a first ALLReduce model parameter value of the current global iteration is determined according to the first node model parameter value and the second node model parameter value.

As shown in FIG. 4, if the finishing of the internal iterations is determined according to k, then an asynchronous ALLReduce communication operation of the model parameter may be initiated in each computing node, that is, for each computing node, a node model parameter value determined by other computing nodes after the internal iterations is acquired through the communication process, and an ALLReduce communication operation is performed to compute and obtain the ALLReduce model parameter value corresponding to the current global iteration.

In step 303, in a case where the current global iteration is a non-first global iteration, a second ALLReduce model parameter value of a last global iteration is acquired through the computation process.

This step and subsequent steps may be performed in parallel with step 302. When the ALLReduce communication operation is being performed, it is determined whether the last initiated asynchronous ALLReduce communication operation is completed. If the last initiated asynchronous ALLReduce communication operation is completed, then a second ALLReduce model parameter value corresponding to the last global iteration, which is obtained by computation after the last initiated asynchronous ALLReduce communication operation, is acquired.

In step 304, a delay penalty amount of the current global iteration is determined through the computation process.

In the embodiments of the present disclosure, the asynchronous nature introduces the noise into the training process, which may lead to the inconsistency between training loss and generalization accuracy. As described above, the optimization may be performed by introducing the delay penalty amount. As shown in FIG. 4, after it waits for the previous asynchronous ALLReduce communication to complete, an updating delay degree (namely, the delay penalty amount) is computed.

For example, this step may include: a variation amplitude of the initial model parameter value of the current global iteration compared with an initial model parameter value of the last global iteration is determined through the computation process; a maximum distance between model parameter values from all model parameter values that are capable of being traversed in the internal iteration of the last global iteration is determined through the computation process; and the delay penalty amount of the current global iteration is determined through the computation process according to a quotient of the variation amplitude and the maximum distance. Therefore, the staleness difference of the external momentum can be accurately quantified, and thus the stability and performance of the overall training are further improved.

Exemplarily, referring to the foregoing expression (1), fᵢ(x)=E_{ζ}_{ᵢ}_{˜D}_{ᵢ}L⁽ⁱ⁾(x; ζᵢ) is a local objective function of the computing node i. Before the staleness difference is constructed, it may be assumed that each fᵢ(x) satisfies L-Lipschitz (lipschitz condition).

For example, it is assumed that for a certain existing L>0, all input x, y∈Rⁿ and i∈{1, 2, . . . , G} satisfy |∇fᵢ(x)−∇fᵢ(y)|≤L|x−y|.

The Lipschitz assumption described above is intuitive because it is indicated that one possible alternative metric for accurately quantifying the gradient difference is to take into account the difference in model parameters, and different versions of model parameters may be used as indices of staleness differences of the external momentum.

In order to quantify the staleness difference in the external momentum, external momentum differences between different iterations, such as an iteration t+1 and an iteration t, may be computed, and the differences are normalized to assess their magnitude.

In consideration of mₜ₊₁=βmₜ+(x_{t, 0}−x_{t, τ}) and mₜ=βmₜ₋₁+(x_{t-1, 0}−x_{t-1, τ}), the staleness difference of mₜ relative to mₜ₊₁ may be expressed as:

$$\vert {m}_{t + 1} - {m}_{t} \vert = \vert β ( {m}_{t} - {m}_{t - 1} ) + ( {x}_{t , 0} - {x}_{t , τ} ) - ( {x}_{t - 1 , 0} - {x}_{t - 1 , τ} ) \vert \leq β \vert ( {m}_{t} - {m}_{t - 1} ) \vert + \vert {x}_{t , 0} - {x}_{t - 1 , 0} \vert + \vert {x}_{t , τ} - {x}_{t - 1 , τ} \vert . \qquad ( 6 )$$

It should be emphasized that at the beginning of the iteration t, the asynchronous ALRReduce operation in progress involving xₜ has typically not been completed. This case means that a global average of x_{t, τ} is not available for all working nodes. In consideration of the result presented in formula (6), a suitable and easy-to-acquire metric for measuring the staleness difference is recorded as Λ, i. e., the delay penalty amount. The delay penalty amount may be defined as follows.

At step t, the staleness difference in the external momentum Λₜ∈Rⁿ is quantified as the ratio of model displacement within the external circulation (the variation amplitude of the initial model parameter value of the current global iteration compared with the initial model parameter value of the last global iteration) to a maximum distance of parameters that are capable of being traversed in the internal iteration (a maximum distance between model parameter values from all model parameter values that are capable of being traversed in the internal iteration of the last global iteration). For example, the maximum distance may be determined according to a product of the number of preset internal iterations and a target difference value, where the target difference value may be a maximum distance between model parameter values from all model parameter values that are capable of being traversed in a single internal iteration.

Exemplarily, in the iteration t−1, it may be expressed as follows:

$${Λ}_{t} = \frac{\vert {x}_{t , 0} - {x}_{t - 1 , 0} \vert}{τ \vert {x}_{t - 1 , 1} - {x}_{t - 1 , 0} \vert} + {1}^{n} \qquad ( 7 )$$

In formula (7), |x_{t,0}−x_{t-1,0}| represents a variation amplitude in model parameters in the external circulation of the iteration t−1 in a case of accompanied by the stale external momentum. τ|x_{t-1,1}−x_{t-1,0}| represents a maximum distance between parameter values that may be traversed in the interior iteration without using the stale exterior momentum. In general, both gradients and learning rates in the internal iteration may be decayed during the training, whereby a reduction of distances in the model parameter value in the single internal iteration occurs, and thus |x_{t-1,1}−x_{t-1,0}| may be adopted to represent a maximum distance achievable in a single internal step. Symbol 1ⁿ represents that Λ is computed model-parameter by model-parameter, where n corresponds to the number of model parameters, that is, all computations in formula (7) are performed element by element.

In step 305, the target momentum of the current global iteration is computed through the computation process according to the initial momentum of the current global iteration, the delay penalty amount of the current global iteration, and the second ALLReduce model parameter value.

As shown in FIG. 4, after the updating delay degree is computed, the external iteration momentum of a single-step delay is updated, that is, the target momentum is computed.

For example, this step may include that: a first difference value between the initial model parameter value of the last global iteration and the second ALLReduce model parameter value is computed through the computation process; a first product of a reciprocal of the delay penalty amount of the current global iteration and the first difference value is computed through the computation process; and a second product of the initial momentum of the current global iteration and a preset momentum factor is computed through the computation process, and a sum of the second product and the first product is computed to obtain the target momentum of the current global iteration. Therefore, the updating of the momentum may be accurately performed based on the computed delay penalty amount.

Exemplarily, the external momentum is penalized when the external momentum is updated. The expression is as follows:

$${m}_{t} = β {m}_{t - 1} + \frac{1}{{Λ}_{t}} \cdot ( {x}_{t - 1 , 0} - {x}_{t - 1 , τ} ) \qquad ( 8 )$$

In step 306, momentum clipping is performed on the target momentum of the current global iteration through the computation process, so that a value of the momentum-clipped target momentum is in a preset interval.

Exemplarily, in order to alleviate a potential situation related to an abnormal value in the external momentum and improve the stability of the overall training, in the embodiments of the present disclosure, coordinate-by-coordinate (that is, model-parameter by model-parameter) external momentum clipping may be used, and the expression of the momentum-clipped target momentum Clip(mₜ, ϕ) is as follows:

$$Clip ( {m}_{t} , ϕ ) = max \{ - ϕ , min \{ {m}_{t} , ϕ \} \} \qquad ( 9 )$$

where ϕ represents a clipping threshold, and ϕ>0 is satisfied.

In step 307, a third product of the momentum-clipped target momentum of the current global iteration and a preset external iteration learning rate is computed through the computation process, and a difference value between the initial model parameter value of the current global iteration and the third product is computed to obtain the target model parameter value of the current global iteration.

As shown in FIG. 4, after the external iteration momentum of the single-step delay is updated, parameter updating of the external iteration is performed, that is, the target model parameter value of the current global iteration is computed.

Exemplarily, the expression of the target model parameter value is as follows:

$${x}_{t + 1 , 0} = {x}_{t , 0} - α \cdot Clip ( {m}_{t} , ϕ ) \qquad ( 10 )$$

As shown in FIG. 4, After the parameter of the external iteration is updated, the number of external iterations is updated, i.e., t=t+1; and the process returns to judge whether the external iteration is finished, that is, judge whether the current t is equal to T. If the current t is equal to T, then the training is finished, and the current target model parameter value is configured to be the model parameter value after the training of the preset model is finished, and if the current t is less than T, then the training of the next global iteration continues.

According to the distributed model training method provided in the embodiments of the present disclosure, a process of performing the iteration training on the model is divided into the internal iteration and the external iteration, the model parameter value is locally updated through a certain number of internal iterations, and after an ALLReduce operation on model parameter values of distributed nodes is triggered, the completion of the ALLReduce operation is not required to be waited. During the ALLReduce operation, the delay penalty amount of the current global iteration may be computed in parallel, a momentum update is performed based on the delay penalty amount and an ALLReduce operation result obtained from the last global iteration, the updated momentum is clipped to prevent the occurrence of an extreme value, and finally the parameter is updated by using the clipped momentum. It not only promotes the overlapping of the inter-node communication and the intra-node computation, effectively improves the training efficiency, better adapts to the distributed computing node cluster with the limited bandwidth, and improves the expandability, but also effectively ensures the stability and performance of the training process.

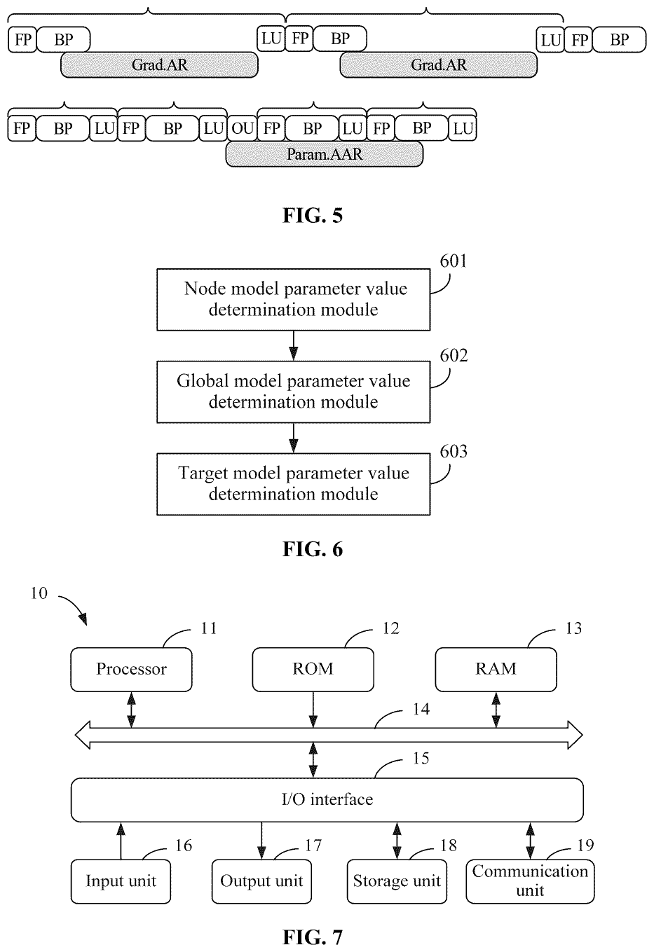

FIG. 5 is a schematic diagram of comparison between a processing flow of a distributed model training method according to an embodiment of the present disclosure and a processing flow in the related art. As shown in FIG. 5, the above one is a processing flow in the related art (such as, SGD), and the below one is a processing flow provided in the embodiments of the present disclosure. White background portions, such as FP, BP, LU, and outer update (OU), are a computation flow (referred to as Comp. Stream); gray background portions, such as gradient AllReduce (referred to as Grad.AR) and parameter asynchronous ALLReduce (referred to as Param.AAR), are a communication stream (referred to as Comm. Stream). AR represents ALLReduce, and ARR represents asynchronous ALLReduce. By comparison, it may be found that a gradient ALLReduce communication operation needs to be performed in the related art, and this operation is time-consuming and is limited by a communication bandwidth. Before the gradient ALLReduce communication operation is completed, the computation flow needs to be in a waiting state, and LU and subsequent FP and BP are allowed to be performed only after the gradient ALLReduce communication operation is completed. However, in the embodiments of the present disclosure, after the number 2 of internal iterations (the specific number of iterations is not limited, which is illustrated as an example in the drawings) are performed, the ALLReduce communication operation of the model parameter is performed asynchronously, and operations such as OU and subsequent FP, BP and LU are performed according to an ALLReduce communication operation result of the model parameter obtained in a computation manner in the last global iteration. In a case where a suitable preset number of internal iterations is selected, the computing flow may be continuously in a working state, whereby the complete overlapping of computation and communication is achieved, and thus the training efficiency is effectively improved.

The distributed model training scheme provided in the embodiments of the present disclosure has been tested on various tasks covering fields such as computer vision and natural language processing, and the various tasks include image classification, semantic segmentation, point cloud processing, autoregressive language modeling, bidirectional language modeling and the like. These extensive experiments verify and demonstrate the capability of the distributed model training scheme provided in the embodiments of the present disclosure in terms of convergence, generalization and expandability, and this can be true even in configurations that include up to 128 A100 GPUs. The experimental results emphasize the superior ability of this scheme to significantly improve the expandability on clusters with 800 Gbps remote direct memory access (RDMA) or 80 Gbps transmission control protocol/internet protocol (TCP/IP) inter-node connections, 100% extendibility can be achieved by fully overlapping communication and computation, and this scheme performs well in a large-scale multi-node cluster with a limited communication bandwidth. Furthermore, a robust theoretical convergence limit is established, so that the powerful evidence is provided for a convergence speed of the scheme which is comparable to a convergence speed of the reference optimizer. In addition, the scheme can be integrated with various optimizers and has good compatibility, such as ZeRO series optimizers. These optimizers have the capability of reducing the memory consumption in a data parallel distributed training scenario, thereby reducing the memory usage for the large-scale model training by applying the technical schemes of the embodiments of the present disclosure.

FIG. 6 is a schematic structural diagram of a distributed model training apparatus according to an embodiment of the present disclosure. As shown in FIG. 6, the apparatus includes a node model parameter value determination module 601, a global model parameter value determination module 602 and a target model parameter value determination module 603. The node model parameter value determination module 601 is configured to perform, through a computation process, the training of an internal iteration with a preset number of internal iterations on a preset model, to obtain a first node model parameter value of a current global iteration, where the preset model includes a machine learning model, and the global iteration includes the internal iteration and an external iteration. The global model parameter value determination module 602 is configured to: acquire, through a communication process, a second node model parameter value of the current global iteration of a second computing node in the distributed system, and determine a first ALLReduce model parameter value of the current global iteration according to the first node model parameter value and the second node model parameter value, where the communication process runs in parallel with the computation process, the second computing node is a computing node in the distributed system except the first computing node, and the second node model parameter value is obtained after the second computing node performs training on the preset model with the preset number of internal iterations. The target model parameter value determination module 603 is configured to: in a case where the current global iteration is a non-first global iteration, acquire, through the computation process, a second ALLReduce model parameter value of a last global iteration, and perform the external iteration by using the second ALLReduce model parameter value to obtain a target model parameter value of the current global iteration, where the target model parameter value of the current global iteration is configured as an initial model parameter value of a next global iteration or a model parameter value after the training on the preset model is finished.

According to the distributed model training apparatus of the embodiments of the present disclosure, the process of performing the iteration training on the model is divided into the internal iteration and the external iteration, the model parameter value is locally updated through a certain number of internal iterations, and after an ALLReduce operation on model parameter values of distributed nodes is triggered, the completion of the ALLReduce operation is not required to be waited. During the ALLReduce operation, an ALLReduce operation result obtained by the last global iteration may be used in parallel, and the ALLReduce operation result is used for performing subsequent external iteration and internal iteration, whereby promoting the overlapping of the inter-node communication and the intra-node computation, and effectively improving the training efficiency. The distributed computing node cluster with the limited bandwidth can be better adapted, and thus the expandability is improved.

In some embodiments, when the external iteration is performed by using the second ALLReduce model parameter value to obtain the target model parameter value of the current global iteration, the target model parameter value determination module is configured to: compute a target momentum of the current global iteration through the computation process according to an initial momentum of the current global iteration and the second ALLReduce model parameter value, where the target momentum of the current global iteration is configured as an initial momentum of the next global iteration; and compute the target model parameter value of the current global iteration through the computation process according to the target momentum of the current global iteration and an initial model parameter value of the current global iteration.

In some embodiments, the step in which the target momentum of the current global iteration is computed through the computation process according to the initial momentum of the current global iteration and the second ALLReduce model parameter value includes: a delay penalty amount of the current global iteration is determined through the computation process; and the target momentum of the current global iteration is computed through the computation process according to the initial momentum of the current global iteration, the delay penalty amount of the current global iteration, and the second ALLReduce model parameter value.

In some embodiments, the step in which the delay penalty amount of the current global iteration is determined through the computation process includes: a variation amplitude of the initial model parameter value of the current global iteration compared with an initial model parameter value of the last global iteration is determined through the computation process; a maximum distance between model parameter values from all model parameter values that are capable of being traversed in the internal iteration of the last global iteration is determined through the computation process; and the delay penalty amount of the current global iteration is determined through the computation process according to a quotient of the variation amplitude and the maximum distance. The step in which the target momentum of the current global iteration is computed through the computation process according to the initial momentum of the current global iteration, the delay penalty amount of the current global iteration, and the second ALLReduce model parameter value includes: a first difference value between the initial model parameter value of the last global iteration and the second ALLReduce model parameter value is computed through the computation process; a first product of a reciprocal of the delay penalty amount of the current global iteration and the first difference value is computed through the computation process; and a second product of the initial momentum of the current global iteration and a preset momentum factor is computed through the computation process, and a sum of the second product and the first product is computed to obtain the target momentum of the current global iteration.

In some embodiments, the step in which the target model parameter value of the current global iteration is computed through the computation process according to the target momentum of the current global iteration and the initial model parameter value of the current global iteration includes: momentum clipping is performed on the target momentum of the current global iteration through the computation process, so that a value of the momentum-clipped target momentum is in a preset interval; and a third product of the momentum-clipped target momentum of the current global iteration and a preset external iteration learning rate is computed through the computation process, and a difference value between the initial model parameter value of the current global iteration and the third product is computed to obtain the target model parameter value of the current global iteration.

The distributed model training apparatus provided in the embodiments of the present disclosure may perform the distributed model training method provided in any of the embodiments of the present disclosure, and has corresponding functional modules and beneficial effects for executing the method.

FIG. 7 shows a schematic structural diagram of an electronic device 10 that may be used for implementing the embodiments of the present disclosure. The electronic device is intended to represent various forms of digital computers, such as laptops, desktops, workstations, personal digital assistants, servers, blade servers, mainframe computers, and other appropriate computers. The electronic device may also represent various forms of mobile apparatuses, such as personal digital assistants, cellular phones, smartphones, wearable devices (such as a helmet, glasses, and a watch), and other similar computation apparatuses. The components shown herein, their connections and relationships between these components, and the functions of these components, are illustrative only and are not intended to limit implementations of the present disclosure described and/or claimed herein.

As shown in FIG. 7, the electronic device 10 includes at least one processor 11 and a memory communicatively connected to the at least one processor 11, such as a read-only memory (ROM) 12 and a random access memory (RAM) 13. The memory stores a computer program that may be executed by the at least one processor. The processor 11 may perform various appropriate actions and processing according to a computer program stored in the read-only memory (ROM) 12 or a computer program loaded from a storage unit 18 to the random access memory (RAM) 13. In the RAM 13, various programs and data required for the operation of the electronic device 10 may be further stored. The processor 11, the ROM 12, and the RAM 13 are connected to each other by using a bus 14. An input/output (I/O) interface 15 is also connected to the bus 14.

Multiple components in the electronic device 10 are connected to the I/O interface 15. The multiple components include: an input unit 16, such as a keyboard and a mouse; an output unit 17 such as various types of displays and speakers; a storage unit 18 such as a magnetic disk or an optical disc; and a communication unit 19, such as a network card, a modem, and a wireless communication transceiver. The communication unit 19 allows the electronic device 10 to exchange information/data with other device by using the computer network such as the Internet and/or various telecommunication networks.

The processor 11 may be a variety of general-purpose and/or dedicated processing assemblies having processing and computation capabilities. Some examples of the processor 11 include, but are not limited to, a central processing unit (CPU), a graphics processing unit (GPU), a variety of special-purpose artificial intelligence (AI) computation chips, a variety of processors running machine learning model algorithms, a digital signal processor (DSP), and any suitable processor, controller, microcontroller, and the like. The processor 11 performs the foregoing methods and processing, such as the distributed model training method.

In some embodiments, the distributed model training method may be implemented as a computer program, and the computer program is tangibly included in a computer-readable storage medium such as a storage unit 18. In some embodiments, part or all of computer programs may be loaded and/or installed on the electronic device 10 via the ROM 12 and/or the communication unit 19. When the computer program is loaded into the RAM 13 and executed by the processor 11, one or more steps of the distributed model training method described above may be performed. Alternatively, in other embodiments, the processor 11 may be configured in any other suitable manner (such as, by means of firmware) to perform the distributed model training method.

Various implementation manners of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, a firmware, a software, and/or a combination thereof. These various implementation manners may include implementation in one or more computer programs, and the one or more computer programs are executable and/or interpretable on a programmable system including at least one programmable processor. The programmable processor may be a special-purpose or general-purpose programmable processor for receiving data and instructions from a memory system, at least one input apparatus and at least one output apparatus and transmitting the data and instructions to the memory system, the at least one input apparatus and the at least one output apparatus.

Computer programs for implementing the methods of the present disclosure may be written in any combination of one or more programming languages. These computer programs may be provided for the processor of a general-purpose computer, a special-purpose computer, or another programmable data processing apparatus to enable the functions/operations specified in a flowchart and/or a block diagram to be implemented when the computer programs are executed by the processor. The computer programs may be executed entirely on a machine, partly on the machine, as a stand-alone software package, partly on the machine and partly on a remote machine, or entirely on the remote machine or server.

In the context of the present disclosure, a computer-readable storage medium may be a tangible medium that may contain or store a computer program available for an instruction execution system, apparatus or device or a computer program used in conjunction with an instruction execution system, apparatus or device. The computer-readable storage medium may include, but is not limited to, an electronic, magnetic, optical, electromagnetic, infrared, or semiconductor system, apparatus, or device, or any appropriate combination of the foregoing. Alternatively, the computer-readable storage medium may be a machine readable signal medium. More examples of the machine-readable storage medium may include an electrical connection based on one or more wires, a portable computer diskette, a hard disk, a random access memory (RAM), a read-only memory (ROM), an erasable programmable read-only memory (EPROM), a flash memory, an optical fiber, a portable compact disc read-only memory (CD-ROM), an optical storage device, a magnetic storage device, or any appropriate combination of the foregoing.

In order to provide the interaction with a user, the systems and technologies described here may be implemented on the electronic device. The electronic device has a display device (such as, a cathode-ray tube (CRT) or liquid-crystal display (LCD) monitor) for displaying information to the user; and a keyboard and a pointing apparatus (such as, a mouse or a trackball) through which the user may provide input to the electronic device. Other kinds of apparatuses may also be used for providing for interaction with the user, for example, feedback provided to the user may be sensory feedback in any form (such as, visual feedback, auditory feedback, or haptic feedback), and input from the user may be received in any form (including acoustic input, speech input, or haptic input).

The systems and technologies described here may be implemented in a computation system including a back-end component (such as, a data server), a computation system including a middleware component (such as, an application server), a computation system including a front-end component (such as, a client computer having a graphical user interface or a web browser through which the user may interact with the implementation manners of the systems and technologies described herein), or a computation system including any combination of such back-end component, middleware component, or front-end component. The components of the system may be interconnected by any form or medium of digital data communication (such as, a communication network). Examples of the communication network include a local area network (LAN), a wide area network (WAN), a blockchain network and the Internet.

A computation system may include a client and a server. The client and the server are generally facing away from each other and typically interact through the communication network. A relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in traditional physical hosts and virtual private server (VPS) service.

An embodiment of the present disclosure further provides a distributed system. The system includes multiple computing nodes, and any one computing node of the multiple computing nodes is configured as the first computing node described in any one of the embodiments of the present disclosure.

An embodiment of the present disclosure further provides a computer program product. The computer program product includes a computer program, and the computer program, when executed by a processor, implements the distributed model training method described in any one of the embodiments of the present disclosure.

It should be understood that various forms of flows, reordering, adding or deleting steps shown above may be used. For example, as long as the desired result of the technical schemes of the present disclosure may be achieved, the steps recited in the present disclosure may be executed in parallel, sequentially or in different orders, which is not limited herein.

The above implementation manners should not be construed as limiting the scope of protection of the present disclosure. It should be understood by those skilled in the art that various modifications, combinations, sub-combinations and substitutions may be made depending on design requirements and other factors. Any modification, equivalent replacement, and improvement made within the spirit and principle of the present disclosure should be included within the scope of protection of the present disclosure.

What is claimed is:

1. A distributed model training method, applied to a first computing node in a distributed system, comprising:
performing, through a computation process, training of an internal iteration with a preset number of internal iterations on a preset model, to obtain a first node model parameter value of a current global iteration, wherein the preset model comprises a machine learning model, and the global iteration comprises the internal iteration and an external iteration;
acquiring, through a communication process, a second node model parameter value of the current global iteration of a second computing node in the distributed system, and determining a first ALLReduce model parameter value of the current global iteration according to the first node model parameter value and the second node model parameter value, wherein the communication process runs in parallel with the computation process, the second computing node is a computing node in the distributed system except the first computing node, and the second node model parameter value is obtained after the second computing node performs training on the preset model with the preset number of internal iterations; and
in response to the current global iteration being a non-first global iteration, acquiring, through the computation process, a second ALLReduce model parameter value of a last global iteration, and performing the external iteration by using the second ALLReduce model parameter value to obtain a target model parameter value of the current global iteration, wherein the target model parameter value of the current global iteration is configured as an initial model parameter value of a next global iteration or a model parameter value after training on the preset model is finished.

2. The method of claim 1, wherein performing, through the computation process, the external iteration by using the second ALLReduce model parameter value to obtain the target model parameter value of the current global iteration comprises:
computing, through the computation process, a target momentum of the current global iteration according to an initial momentum of the current global iteration and the second ALLReduce model parameter value, wherein the target momentum of the current global iteration is configured as an initial momentum of the next global iteration; and
computing, through the computation process, the target model parameter value of the current global iteration according to the target momentum of the current global iteration and an initial model parameter value of the current global iteration.

3. The method of claim 2, wherein computing, through the computation process, the target momentum of the current global iteration according to the initial momentum of the current global iteration and the second ALLReduce model parameter value comprises:
determining, through the computation process, a delay penalty amount of the current global iteration; and
computing, through the computation process, the target momentum of the current global iteration according to the initial momentum of the current global iteration, the delay penalty amount of the current global iteration, and the second ALLReduce model parameter value.

4. The method of claim 3, wherein determining, through the computation process, the delay penalty amount of the current global iteration comprises:
determining, through the computation process, a variation amplitude of the initial model parameter value of the current global iteration compared with an initial model parameter value of the last global iteration;
determining, through the computation process, a maximum distance between model parameter values from all model parameter values that are capable of being traversed in an internal iteration of the last global iteration; and
determining, through the computation process, the delay penalty amount of the current global iteration according to a quotient of the variation amplitude and the maximum distance;
wherein computing, through the computation process, the target momentum of the current global iteration according to the initial momentum of the current global iteration, the delay penalty amount of the current global iteration, and the second ALLReduce model parameter value comprises:
computing, through the computation process, a first difference value between the initial model parameter value of the last global iteration and the second ALLReduce model parameter value;
computing, through the computation process, a first product of a reciprocal of the delay penalty amount of the current global iteration and the first difference value; and
computing, through the computation process, a second product of the initial momentum of the current global iteration and a preset momentum factor, and computing a sum of the second product and the first product to obtain the target momentum of the current global iteration.

5. The method of claim 2, wherein computing, through the computation process, the target model parameter value of the current global iteration according to the target momentum of the current global iteration and the initial model parameter value of the current global iteration comprises:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.

6. The method of claim 3, wherein computing, through the computation process, the target model parameter value of the current global iteration according to the target momentum of the current global iteration and the initial model parameter value of the current global iteration comprises:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.

7. The method of claim 4, wherein computing, through the computation process, the target model parameter value of the current global iteration according to the target momentum of the current global iteration and the initial model parameter value of the current global iteration comprises:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.

8. An electronic device, comprising:
at least one processor; and
a memory communicatively connected to the at least one processor;
wherein the memory stores a computer program executable by the at least one processor, and the computer program, when executed by the at least one processor, causes the at least one processor to perform:
performing, by a first computing node in a distributed system through a computation process, training of an internal iteration with a preset number of internal iterations on a preset model, to obtain a first node model parameter value of a current global iteration, wherein the preset model comprises a machine learning model, and the global iteration comprises the internal iteration and an external iteration;
acquiring, through a communication process, a second node model parameter value of the current global iteration of a second computing node in the distributed system, and determining a first ALLReduce model parameter value of the current global iteration according to the first node model parameter value and the second node model parameter value, wherein the communication process runs in parallel with the computation process, the second computing node is a computing node in the distributed system except the first computing node, and the second node model parameter value is obtained after the second computing node performs training on the preset model with the preset number of internal iterations; and
in response to the current global iteration being a non-first global iteration, acquiring, through the computation process, a second ALLReduce model parameter value of a last global iteration, and performing the external iteration by using the second ALLReduce model parameter value to obtain a target model parameter value of the current global iteration, wherein the target model parameter value of the current global iteration is configured as an initial model parameter value of a next global iteration or a model parameter value after training on the preset model is finished.

9. The electronic device of claim 8, wherein the computer program, when executed by the at least one processor, causes the at least one processor to perform performing, through the computation process, the external iteration by using the second ALLReduce model parameter value to obtain the target model parameter value of the current global iteration by:
computing, through the computation process, a target momentum of the current global iteration according to an initial momentum of the current global iteration and the second ALLReduce model parameter value, wherein the target momentum of the current global iteration is configured as an initial momentum of the next global iteration; and
computing, through the computation process, the target model parameter value of the current global iteration according to the target momentum of the current global iteration and an initial model parameter value of the current global iteration.

10. The electronic device of claim 9, wherein the computer program, when executed by the at least one processor, causes the at least one processor to perform computing, through the computation process, the target momentum of the current global iteration according to the initial momentum of the current global iteration and the second ALLReduce model parameter value by:
determining, through the computation process, a delay penalty amount of the current global iteration; and
computing, through the computation process, the target momentum of the current global iteration according to the initial momentum of the current global iteration, the delay penalty amount of the current global iteration, and the second ALLReduce model parameter value.

11. The electronic device of claim 10, wherein the computer program, when executed by the at least one processor, causes the at least one processor to perform determining, through the computation process, the delay penalty amount of the current global iteration by:
determining, through the computation process, a variation amplitude of the initial model parameter value of the current global iteration compared with an initial model parameter value of the last global iteration;
determining, through the computation process, a maximum distance between model parameter values from all model parameter values that are capable of being traversed in an internal iteration of the last global iteration; and
determining, through the computation process, the delay penalty amount of the current global iteration according to a quotient of the variation amplitude and the maximum distance;
wherein the computer program, when executed by the at least one processor, causes the at least one processor to perform computing, through the computation process, the target momentum of the current global iteration according to the initial momentum of the current global iteration, the delay penalty amount of the current global iteration, and the second ALLReduce model parameter value by:
computing, through the computation process, a first difference value between the initial model parameter value of the last global iteration and the second ALLReduce model parameter value;
computing, through the computation process, a first product of a reciprocal of the delay penalty amount of the current global iteration and the first difference value; and
computing, through the computation process, a second product of the initial momentum of the current global iteration and a preset momentum factor, and computing a sum of the second product and the first product to obtain the target momentum of the current global iteration.

12. The electronic device of claim 9, wherein the computer program, when executed by the at least one processor, causes the at least one processor to perform computing, through the computation process, the target model parameter value of the current global iteration according to the target momentum of the current global iteration and the initial model parameter value of the current global iteration by:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.

13. The electronic device of claim 10, wherein the computer program, when executed by the at least one processor, causes the at least one processor to perform computing, through the computation process, the target model parameter value of the current global iteration according to the target momentum of the current global iteration and the initial model parameter value of the current global iteration by:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.

14. The electronic device of claim 11, wherein the computer program, when executed by the at least one processor, causes the at least one processor to perform computing, through the computation process, the target model parameter value of the current global iteration according to the target momentum of the current global iteration and the initial model parameter value of the current global iteration by:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.

15. A non-transitory computer-readable storage medium, storing a computer instruction, wherein the computer instruction is configured to, when executed by a processor, implement:
performing, by a first computing node in a distributed system through a computation process, training of an internal iteration with a preset number of internal iterations on a preset model, to obtain a first node model parameter value of a current global iteration, wherein the preset model comprises a machine learning model, and the global iteration comprises the internal iteration and an external iteration;
acquiring, through a communication process, a second node model parameter value of the current global iteration of a second computing node in the distributed system, and determining a first ALLReduce model parameter value of the current global iteration according to the first node model parameter value and the second node model parameter value, wherein the communication process runs in parallel with the computation process, the second computing node is a computing node in the distributed system except the first computing node, and the second node model parameter value is obtained after the second computing node performs training on the preset model with the preset number of internal iterations; and
in response to the current global iteration being a non-first global iteration, acquiring, through the computation process, a second ALLReduce model parameter value of a last global iteration, and performing the external iteration by using the second ALLReduce model parameter value to obtain a target model parameter value of the current global iteration, wherein the target model parameter value of the current global iteration is configured as an initial model parameter value of a next global iteration or a model parameter value after training on the preset model is finished.

16. The storage medium of claim 15, wherein the computer instruction is configured to, when executed by the processor, implement performing, through the computation process, the external iteration by using the second ALLReduce model parameter value to obtain the target model parameter value of the current global iteration by:
computing, through the computation process, a target momentum of the current global iteration according to an initial momentum of the current global iteration and the second ALLReduce model parameter value, wherein the target momentum of the current global iteration is configured as an initial momentum of the next global iteration; and
computing, through the computation process, the target model parameter value of the current global iteration according to the target momentum of the current global iteration and an initial model parameter value of the current global iteration.

17. The storage medium of claim 16, wherein the computer instruction is configured to, when executed by the processor, implement computing, through the computation process, the target momentum of the current global iteration according to the initial momentum of the current global iteration and the second ALLReduce model parameter value by:
determining, through the computation process, a delay penalty amount of the current global iteration; and
computing, through the computation process, the target momentum of the current global iteration according to the initial momentum of the current global iteration, the delay penalty amount of the current global iteration, and the second ALLReduce model parameter value.

18. The storage medium of claim 17, wherein the computer instruction is configured to, when executed by the processor, implement determining, through the computation process, the delay penalty amount of the current global iteration by:
determining, through the computation process, a variation amplitude of the initial model parameter value of the current global iteration compared with an initial model parameter value of the last global iteration;
determining, through the computation process, a maximum distance between model parameter values from all model parameter values that are capable of being traversed in an internal iteration of the last global iteration; and
determining, through the computation process, the delay penalty amount of the current global iteration according to a quotient of the variation amplitude and the maximum distance;
wherein the computer instruction is configured to, when executed by the processor, implement computing, through the computation process, the target momentum of the current global iteration according to the initial momentum of the current global iteration, the delay penalty amount of the current global iteration, and the second ALLReduce model parameter value by:
computing, through the computation process, a first difference value between the initial model parameter value of the last global iteration and the second ALLReduce model parameter value;
computing, through the computation process, a first product of a reciprocal of the delay penalty amount of the current global iteration and the first difference value; and
computing, through the computation process, a second product of the initial momentum of the current global iteration and a preset momentum factor, and computing a sum of the second product and the first product to obtain the target momentum of the current global iteration.

19. The storage medium of claim 16, wherein the computer instruction is configured to, when executed by the processor, implement computing, through the computation process, the target model parameter value of the current global iteration according to the target momentum of the current global iteration and the initial model parameter value of the current global iteration by:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.

20. The storage medium of claim 17, wherein the computer instruction is configured to, when executed by the processor, implement computing, through the computation process, the target model parameter value of the current global iteration according to the target momentum of the current global iteration and the initial model parameter value of the current global iteration by:
performing, through the computation process, momentum clipping on the target momentum of the current global iteration so that a value of the momentum-clipped target momentum is in a preset interval; and
computing, through the computation process, a third product of the momentum-clipped target momentum of the current global iteration and a preset external iteration learning rate, and computing a difference value between the initial model parameter value of the current global iteration and the third product to obtain the target model parameter value of the current global iteration.
